(19) United States
(12) Patent Application Publication
(10) Pub. No.: US 2009/0045782 A1
(43) Pub. Date: Feb. 19, 2009

(54) POWER CONVERSION SYSTEM

(75) Inventors: Rajib Datta, Niskayuna, NY (US); Allen Michael Ritter, Roanoke, VA (US); Haiqing Weng, Shanghai (CN); Luis Jose Garces, Niskayuna, NY (US); Kunlun Chen, Shanghai (CN); Haitao Zhang, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/839,929

(22) Filed: Aug. 16, 2007

(51) Int. Cl. H02P 9/00; F04B 17/00; H02M 7/00

(52) U.S. Cl. 322/17; 363/64; 417/321

(57) ABSTRACT

A power conversion system includes two three-level converters, and a phase shifted transformer coupled to the converters.

### BACKGROUND

The systems disclosed herein relate generally to power conversion systems and more specifically to power conversion systems that are particularly suitable for high-speed machines.

High-speed compressor drive trains for oil and gas applications would benefit from high-speed electrical machines operating at multi-megawatt power levels. Such high-speed machines would also be useful for directly driving generators with gas turbines for shipboard and mobile power generation applications.

High-speed machines are machines with either a high mechanical speed of the rotor or a high electrical frequency (which is a function of the mechanical speed and the number of poles of the machine). In one example, high-speed is defined as being at least 6000 rpm and is typically on the order of 25,000 rpm for lower power machines and 7000 rpm for higher power machines. In another example, high frequency is defined as being at least 100 Hz or more specifically on the order of 400 Hz or 600 Hz or one kHz or more with the selected frequency depending upon machine size and pole number. High power machines are typically defined as being in the megawatt range.

Typically, induction machines are used when high speeds are required. However, it would be desirable to use high-speed machines that comprise permanent magnet rotors due to reduced rotor losses and higher power densities than induction machines. Permanent magnet type machines are also well suited for constrained space, hazardous, and remote environments.

In some applications, high-speed machine requirements for both high power and high fundamental frequency are beyond the capability of conventional industrial drive systems. For example, limited switching frequency capabilities of conventional high power devices result in three-level configurations not being used to reach beyond 200 Hz fundamental frequency with acceptable power quality at the machine terminals. Challenges include excessive rotor heating (in induction machines) or rotor shield heating (in permanent magnet machines) and high torque ripple with low order harmonics.

To address such constraints, some proposals have been made for converter topologies with higher numbers of levels than three. Five level architectures with neutral-point clamped or flying-capacitor topologies typically require complex modulator design and voltage balancing.

Other proposals have included cascaded, series-cell topologies with low voltage IGBT modules. Such topologies have been reported to run at 400 Hz with 10 MW permanent magnet motors. At increasing power levels, corresponding increases occur in the number of components, the number of DC links that must be balanced, and the complexity of the line-side transformer.

Another proposal has been the use of two three-level IGCT converters in an open-delta configuration to synthesize fundamental output frequencies on the order of 200 Hz. The proposed topology does not appear to be scalable to frequencies much higher than 200 Hz at high power because of the degrading power quality attributed to limited switching capabilities of IGCTs. The fifth and seventh harmonics present in the resulting voltage waveform would appear to cause current and toque ripple at high frequencies.

Still another proposal has been a three-level IGBT converter with press-pack devices in combination with a large output filter. This approach has been reported to achieve fundamental frequencies in the range of 250 Hz. Again, it is not clear that this approach is scalable to higher frequencies because of difficulty in using passive filters to isolate the switching frequency components from the fundamental component.

It would be desirable to have an improved converter system for high power high frequency power conversion for electrical drives.

### BRIEF DESCRIPTION

In one embodiment disclosed herein, a power conversion system comprises two three-level converters and a phase shifted transformer coupled to the converters.

In another embodiment disclosed herein, a power conversion system for oil and gas recovery comprises: an input transformer configured for receiving power from a power grid; two three-level converters; a rectifier coupling the input transformer to the converters; a phase shifted output transformer coupled to the converters; a motor coupled to the output transformer; and a compressor coupled to the motor and configured for recovery of oil, gas, or combinations thereof.

In another embodiment disclosed herein, a power conversion system for power generation comprises: a generator; a phase shifted transformer configured for receiving power from the generator; two three-level converters coupled to the phase shifted transformer, wherein the converters each comprise a plurality of converter switches; and a controller for selecting switching patterns of the converter switches to result in one converter being out of phase with another converter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a high-speed electrical machine configuration.

FIG. 2 is a circuit diagram including a converter topology in accordance with embodiments disclosed herein.

FIG. 3 is a block diagram of a specific embodiment of converters and a transformer of FIG. 2.

FIG. 4 is a simulated graph illustrating simulated voltages and currents over time.

FIG. 5 is a set of graphs illustrating several examples of switching patterns.

FIG. 6 is a simulated graph of switching frequency vs. fundamental frequency.

FIG. 7 is a set of simulated graphs illustrating voltage, current, and torque waveforms and frequency spectra for a fifteen MW, 370 Hz embodiment.

FIG. 8 is a set of simulated graphs illustrating voltage, current, and torque waveforms and frequency spectra for a six MW, 570 Hz embodiment.

FIG. 9 is a circuit diagram including a converter topology in accordance with another embodiments disclosed herein.

### DETAILED DESCRIPTION

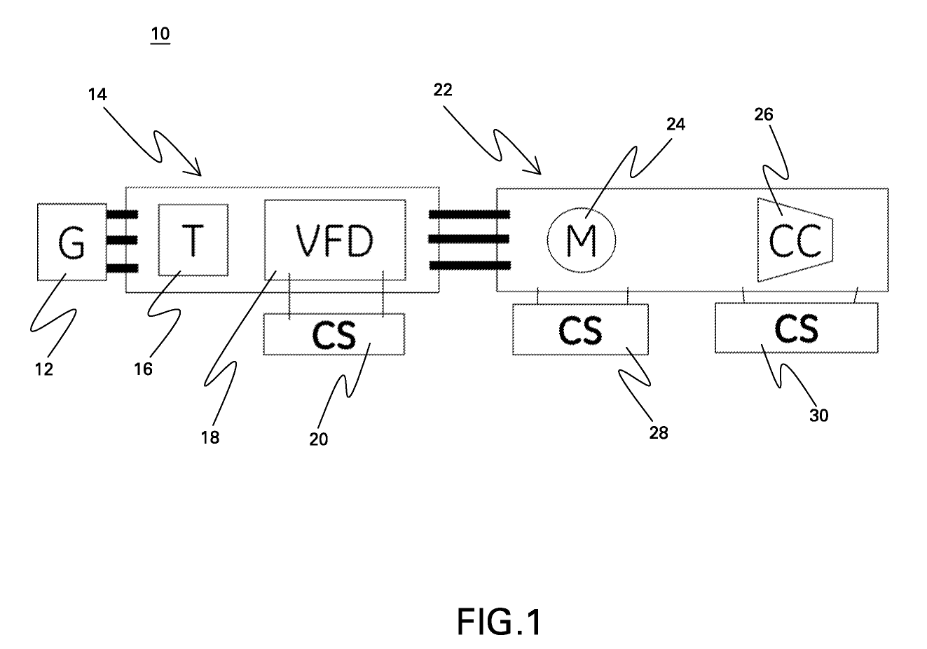

FIG. 1 is a block diagram of a power conversion system 10. In the embodiment of FIG. 1, power is initially supplied from a power grid 12 to a drive system 14 that converts the power for use in a machine system 22. Power grid 12 is typically a 50 Hz or 60 Hz grid. Drive system 14 is shown for purposes of example in FIG. 1 as including an input transformer 16, a variable frequency drive 18, and a controller 20. Machine system 22 is shown for purposes of example as including a motor 24 driving a compressor 26 and as including associated controllers 28 and 30. Although a plurality of controllers is shown, the controls may be embodied in a single unit or a plurality of units. Embodiments disclosed herein are believed to be particularly useful for driving high-speed electrical machines such as motors used in oil and gas recovery.

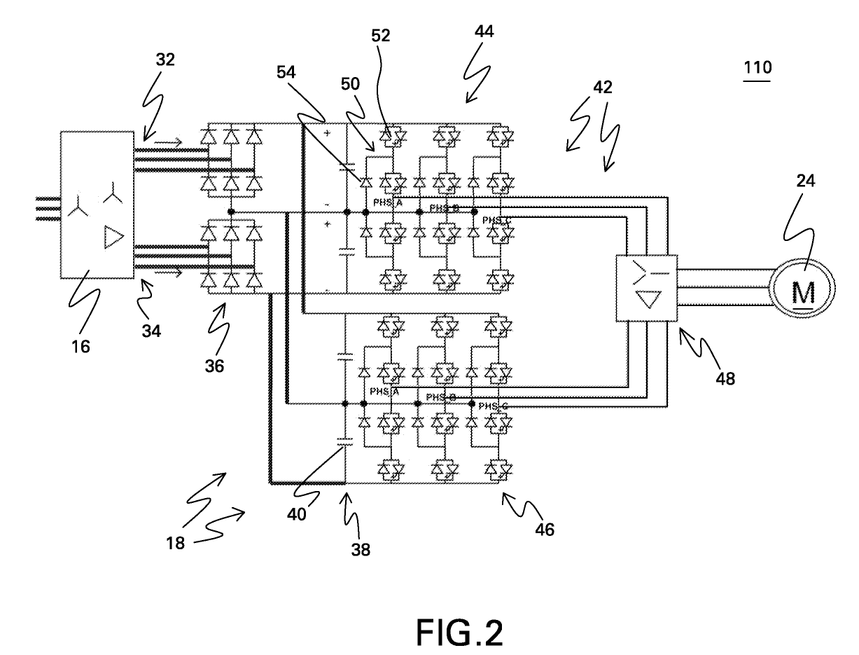

FIG. 2 is a circuit diagram including a converter topology in accordance with embodiments disclosed herein wherein power conversion system 110 comprises two converters 44, 46 (meaning at least two converters), with each converter comprising three output levels (meaning at least three output levels), and a phase shifted output transformer 48 (meaning at least one phase shifted output transformer) coupled to the converters. Power conversion system embodiments disclosed herein may be used to operate at frequencies in the range extending up to at least 300 Hertz. In a more specific embodiment, the frequency range extends up to at least 400 Hertz. In an even more specific embodiment, the frequency range extends up to at least 600 Hertz.

In one embodiment, power conversion system 110 further comprises input transformer 16 and a rectifier 36 coupling input transformer 16 to converters 44 and 46. In a more specific embodiment, input transformer 16 comprises two secondary windings 32 and 34 with one secondary winding 32 being star wound and another secondary winding 34 being delta wound. This arrangement is useful for reducing harmonic components in diode rectifier 36. In one example, input transformer 16 comprises a twelve pulse input transformer, and rectifier 36 comprises a twelve pulse rectifier. In another example, input diodes of diode rectifier 36 comprise silicon controlled rectifier type diodes (not shown). Such diodes allow the system to operate with variable DC bus voltage and thus provide another (continuously variable) degree of freedom in the generation of the output voltage.

Converters 44 and 46 are coupled to rectifier 36 by a DC link 38, and each may comprise any appropriate configuration with one example being a three-phase AC-to-DC neutral point clamped bridge configuration. Although the illustrated embodiment of two three-level converters is shown for purposes of example, in some embodiments, more than two converters may be used and higher numbers of output levels may also or alternatively be used such five output levels, for example.

In the embodiment of FIG. 2, each leg 50 of each of each converter has four switches 52 coupled in series and two diodes 54 coupled back to DC link 38. The output for each leg may be on the positive, negative, or neutral point (mid-point) with the neutral point being clamped by diodes 54. Controller 20 (FIG. 1) is used for deriving switching patterns for the converter switches 52 to minimize harmonic distortion and to control torque and flux that are supplied to the electrical machine.

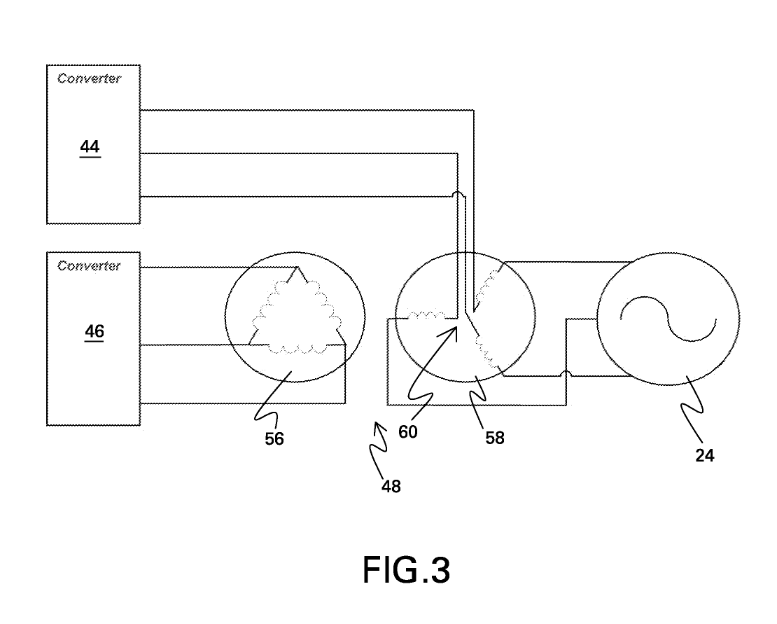

FIG. 3 is a block diagram of a specific embodiment of the transformer and converters of FIG. 2 wherein output transformer 48 comprises a delta wound primary winding 56 and an open star wound secondary winding 58 (with neutral 60 not being coupled). One converter 46 is coupled to primary winding 56 and another converter 44 is coupled to secondary winding 58. This embodiment results in a thirty degree phase shift with respect to the voltage from converter 46 that enters and leaves the transformer. To bring the output of transformer 48 back in phase for machine 24, controller 20 (FIG. 1) may be used to select switching patterns of the converter switches to result in the one converter being thirty degrees out of phase with the other converter in the opposite direction of the phase shift that occurs in transformer 48. In one example, the phase of converter 46 is controlled to be offset from the phase required by the machine 24, the phase of converter 44 is controlled to be substantially in phase with machine 24, and then, when the phase of the voltage from converter 46 is shifted by the delta-start configuration, the voltage from both converters is in the proper phase.

The resulting waveform from the addition of the voltages of converters 44 and 46 is expected to have reduced harmonic distortion (particularly on the 5^{th} and 7^{th} orders) and thus improved power quality as compared with a straight addition of the voltages without the delta-star configuration of transformer 48. Transformer 48 is selected to operate at frequencies needed to run machine 24.

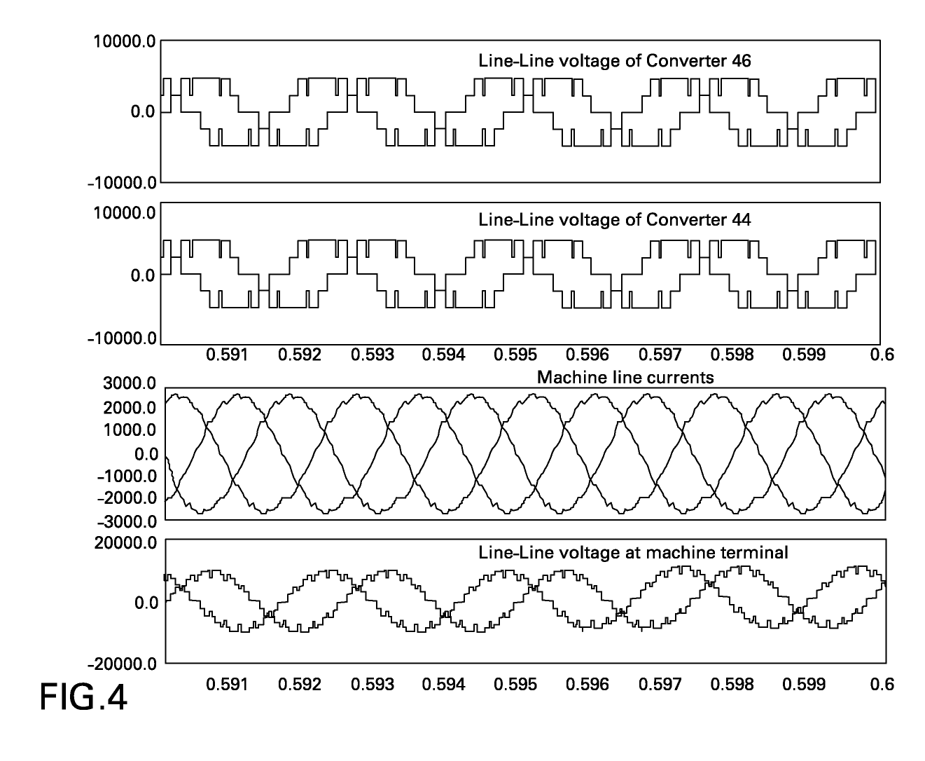

FIG. 4 is a simulated graph illustrating simulated voltages and currents over time. The simulated line-to-line voltages of converters 46 and 44 illustrate the use of three level converters to generate five line-to-line voltage levels. By applying the above described phase shifts via the output transformer configuration and appropriate switching of the converters, the curves at the machine terminals are expected to be even more smooth than the curves taken directly from the converters.

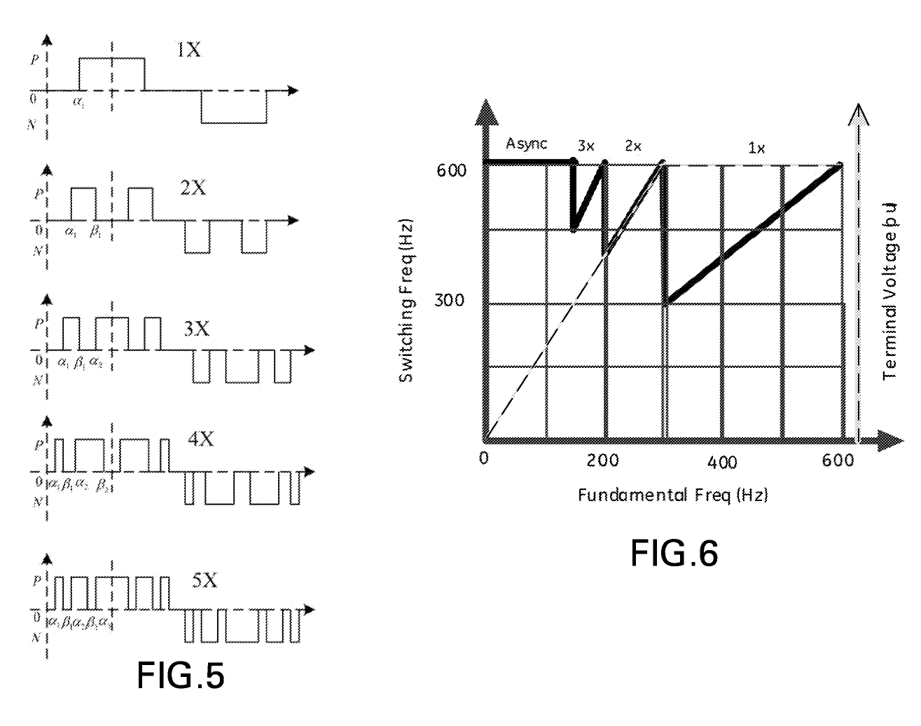

FIG. 5 is a set of graphs illustrating several examples of switching patterns, and FIG. 6 is a simulated graph of switching frequency vs. fundamental frequency. In FIG. 5, the 1× example relates to switching every switch on and off once per fundamental cycle. The 2 or more (N) examples relate to having N pulses on each positive half of a fundamental cycle and N pulses on each negative half of a fundamental cycle. By adjusting the lengths of the pulses, the waveforms may be modulated. FIG. 6 illustrates switching patterns that vary with respect to fundamental frequency of the power.

When converters are switched with synchronous switching patterns and low pulse count, to avoid reducing output power quality, the switching frequency of the active switches may be limited to the fundamental frequency at the highest machine speed. When designing converters for high power applications, the switch frequencies are limited due to the switch ratings typically being several amperes of current and several kilovolts of blocking voltage. Typically such switch frequencies are less than about one kHz and more specifically in the range of 500 Hz to 800 Hz. To obtain a smoother output power waveform, modulation may be incorporated into the switching of the inverters. Two examples of modulation include synchronous pulse width modulation (PWM) and asynchronous modulation.

When synchronous PWM is used, switching instances are synchronized to the fundamental frequency. For example, as can be seen in the line-to-line voltage waveforms of FIG. 4, notches (switches) occur at the same point in the waveform in each cycle, and the waveforms have quarter wave and half wave symmetry.

When asynchronous modulation is used, the switching events are not synchronized to the fundamental frequency. The switching events for asynchronous modulation may be determined in one embodiment by comparing the fundamental frequency voltage command waveforms to one or more fixed frequency carrier waveforms. The frequency of the carrier waveform is selected to be at least one order of magnitude higher than the fundamental frequency to obtain desired power quality of the output voltages. Practically, the carrier frequency is limited by the maximum switching frequency of the semiconductor switches. Hence, asynchronous modulation methods provide low harmonic distortion at low fundamental frequencies; however, the harmonic distortion increases with increases in fundamental frequency, and the power quality may not be acceptable at high fundamental frequencies.

As illustrated in FIG. 6, the switching frequency of the converter switches is varied as a function of the fundamental frequency. The modulation strategy is designed such that at the highest fundamental frequency, the switching frequency of each device is the same as the fundamental frequency, thereby ensuring that the devices operate within their thermal capabilities. This mode of switching is referred to as 1× mode. However, as the fundamental frequency reduces, it is possible to switch each device at 2 or 3 times the fundamental frequency as shown in FIG. 6 as 2× and 3× modes. Therefore, the switching patterns may be varied as a function of the fundamental frequency to minimize the number of switching events per fundamental cycle. In this example, synchronous modulation is used between 150 Hertz and 600 Hertz, while at start-up (between zero Hertz and 150 Hertz) asynchronous modulation with fixed switching frequency is used.

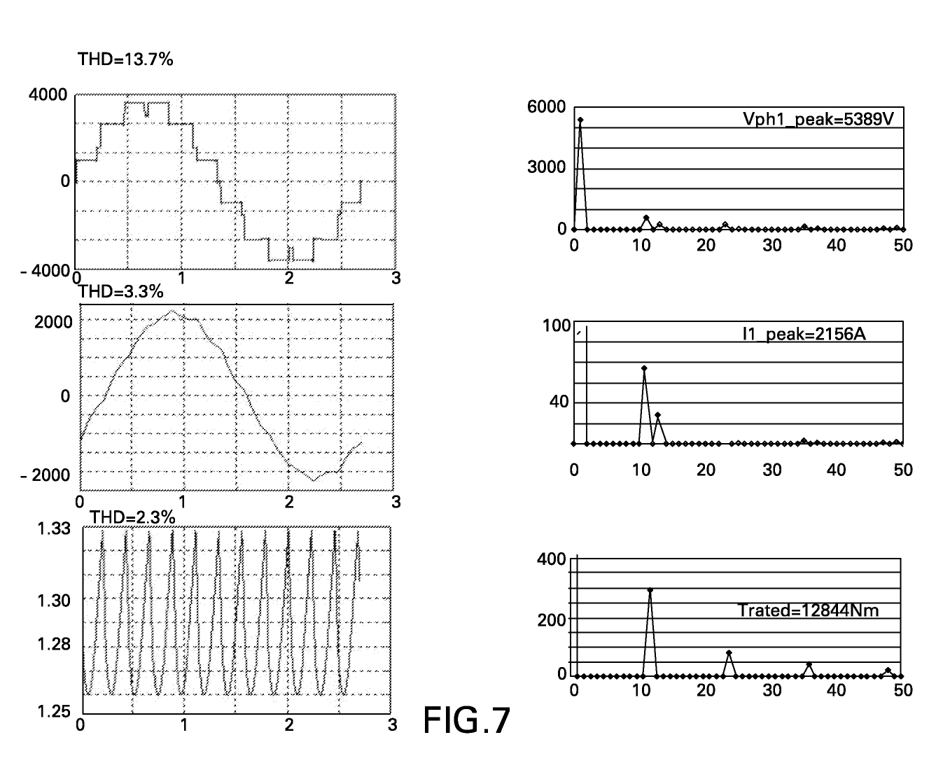

The switching patterns, as shown in FIG. 5, are designed to achieve high power quality at the load over the entire operating speed range. For any switching pattern used in synchronous modulation, the switching angles at which the switching events take place may be calculated to reduce output harmonic distortion. The placement of the pulses, in combination with the phase shift introduced through the output transformer results in eliminating certain harmonics as shown in FIG. 7. In one embodiment, the switching angles in the different patterns for reduced harmonic distortion are calculated off-line and stored in a static look-up table. During operation of the power conversion system, the information about the instantaneous switching state is retrieved from the look up table depending on the modulation index and the phase angle.

In one embodiment, the look up table is assembled using commercially available software such as MATLAB Optimization Toolbox. An example procedure is described in the following steps. As a first step, initial results are obtained without considering any line-to-line minimum pulse limitations. In the first step, design targets, the constraints, and acceptable ranges of solutions are specified for each modulation index and provided to software such as the MATLAB Optimization Toolbox. A set of switching angles corresponding to each modulation index and the corresponding scaled THD (total harmonic distortion) is provided by the software. In the second step, a few points of the first set are manually selected as starting points for recalculating the data with the constraint of line-to-line minimum pulse limitation. The calculations in the second set are extended for increasing and decreasing modulation indices around the selected points with the intent to obtain continuity in the switching angles within the selected segments. In the third step, data from each segment as obtained in the second step is manually investigated and compared to determine how different slices from these segments can be combined to form the final data table. The main tradeoff is between continuity of switching angles over the maximum possible range of modulation index and minimum scaled THD. In the fourth step, each adjusted segment from the third step is extended again on both sides to introduce a hysteresis band. Finally each data segment is checked for output voltage accuracy and minimum-pulse limitation.

In another embodiment, which may either be distinct from or combined with the reduced total harmonic distortion embodiment, switching patterns are varied to reduce losses of the switches. The look up table described above may be constructed with loss constraints selected to limit device turnoff losses, conduction losses, or other loss parameters. This is possible due to the multiplicity of patterns that will result in the same speed, same load, and acceptable THD. Although using additional criteria to place the pulses may affect the degree of THD reduction, such affects may be acceptable in some embodiments. The patterns could be adjusted to conserve margin to the THD or conduction or turn off or other operation sustaining limit depending on the present operating conditions where the placement of pulses in the patterns has an impact.

When a simulation was run to evaluate machine voltage, current, and torque for a fifteen MW, 370 Hz embodiment, the THD on the phase A voltage was calculated to be 13.7%, the THD on the phase A current was calculated to be 3.3%, and the THD on the phase A torque was calculated to be 2.3%. Additionally frequency spectra for the voltage, current, and torque were also simulated to view the harmonic content. The representative graphs are illustrated in FIG. 7.

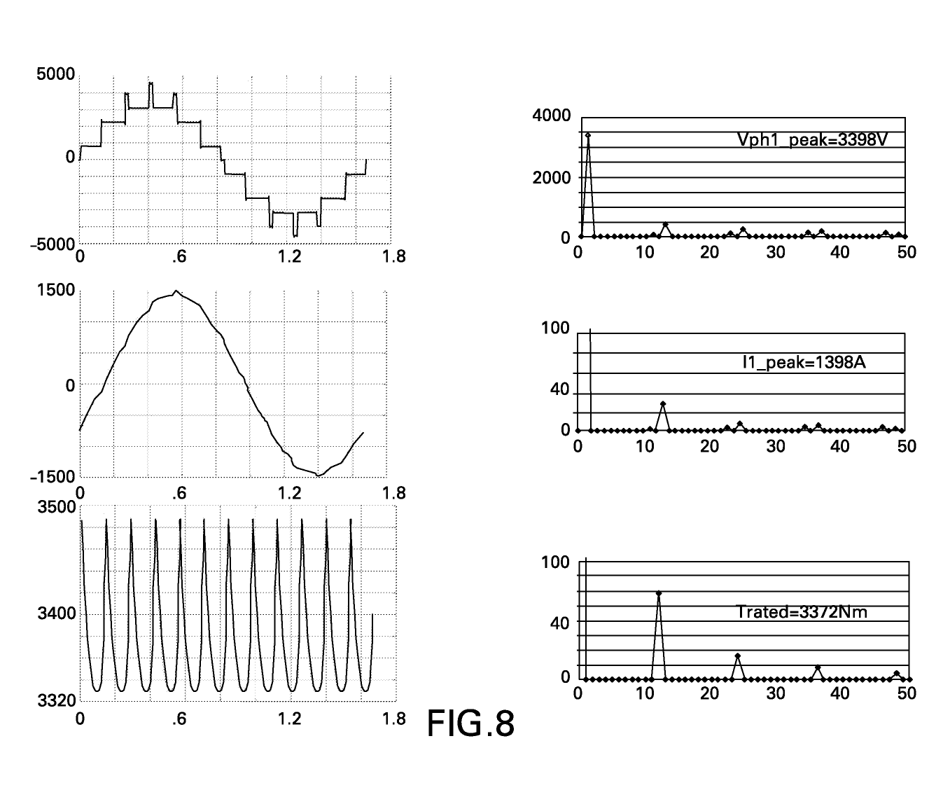

When a simulation was run to evaluate machine voltage, current, and torque for a six MW, 570 Hz embodiment, the THD on the phase A voltage was calculated to be 17.8%, the THD on the phase A current was calculated to be 2.1%, and the THD on the phase A torque was calculated to be 2.0%. Again frequency spectra for the voltage, current, and torque were also simulated to view the harmonic content. The representative graphs are illustrated in FIG. 8.

The above discussed embodiments may be applied in any desired manner or combination. In one specific embodiment combining elements of FIGS. 1-3, for example, a power conversion system 10 for oil and gas recovery comprises: an input transformer 16 configured for receiving power from a power grid 12; two three-level converters 44, 46; a rectifier 36 coupling the input transformer to the converters; a phase shifted output transformer 48 coupled to the converters; a motor 24 coupled to the output transformer; and a compressor 26 coupled to the motor and configured for recovery of oil, gas, or combinations thereof.

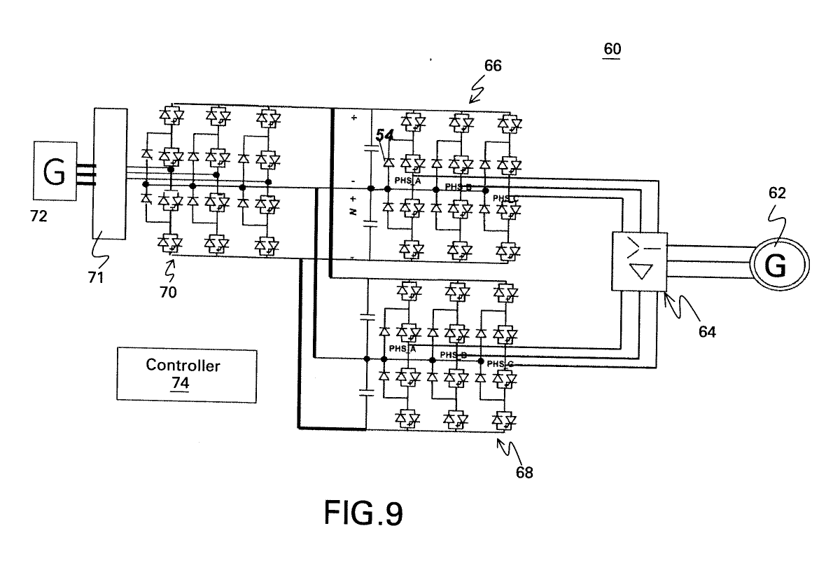

FIG. 9 is a circuit diagram including a converter topology in accordance with another embodiments disclosed herein. The embodiment of FIG. 9 is similar to that of FIG. 2 except that rectifier 16 of FIG. 2 is replaced by converter 70. When converter 70 comprises a bidirectional converter, the system may operate in either a power receiving or generating mode. In one embodiment, a power conversion system 60 comprises: a generator 62; a phase shifted transformer 64 configured for receiving power from the generator; two three-level converters 66 and 68 coupled to the input transformer and each comprising a plurality of converter switches; and a controller 74 for selecting switching patterns of the converter switches to result in one converter being out of phase with another converter. In the embodiment of FIG. 9, transformer 71 couples power from converter 70 to a grid 72.

Embodiments disclosed herein have various advantages and, in one aspect, provide a method of obtaining high fundamental frequency output at high power with high power quality. For example, the ability to achieve a fundamental frequency of 600 Hz at a power of five MW to six MW allows four-pole machines to be built with rotor balancing advantages. Standard reliable hardware building blocks using three level neutral-pointed-clamped IGCT converters may be incorporated and used in various configurations tailored for different applications.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power conversion system comprising:
two converters, each converter comprising three output levels;
a phase shifted transformer coupled to the converters.

2. The power conversion system of claim 1 wherein the power conversion system is operable in a frequency range extending up to at least 300 Hertz.

3. The power conversion system of claim 2 wherein the power conversion system is operable in a frequency range extending up to at least 400 Hertz.

4. The power conversion system of claim 2 wherein the power conversion system is operable in the frequency range extending up to at least 600 Hertz.

5. The power conversion system of claim 2 wherein the transformer comprises a delta wound primary winding 56 and an open star wound secondary winding 58, and wherein one converter is coupled to the primary winding and another converter is coupled to the secondary winding.

6. The power conversion system of claim 5 wherein the converters each comprise a plurality of converter switches and further comprising a controller for selecting switching patterns of the converter switches to result in the one converter being thirty degrees out of phase with the another converter.

7. The power conversion system of claim 6 wherein the controller is further configured for varying the switching patterns as a function of fundamental frequency to reduce a number of switching events.

8. The power conversion system of claim 7 wherein the controller is further configured for selecting switching angles in the switching patterns to reduce output harmonic distortion.

9. The power conversion system of claim 7 wherein the controller is further configured for varying the switching patterns to reduce losses of the converter switches.

10. The power conversion system of claim 2 wherein the transformer comprises an output transformer and further comprising an input transformer configured for receiving power from a power grid; and
a rectifier coupling the input transformer to the converters.

11. The power conversion system of claim 10 wherein the input transformer comprises two secondary windings 32 and 34 with one secondary winding being star wound and another secondary winding being delta wound.

12. The power conversion system of claim 11 wherein the input transformer comprises a twelve pulse input transformer, and wherein the rectifier comprises a twelve pulse rectifier.

13. The power conversion system of claim 2 wherein the transformer comprises an input transformer, the converters comprise primary converters and further comprising an additional converter configured for coupling the primary converters to a power grid.

14. The power conversion system of claim 2 wherein each converter comprises a three phase converter.

15. The power conversion system of claim 14 wherein each converter comprises a neutral point clamped converter.

16. A power conversion system for oil and gas recovery, the power conversion system comprising:
an input transformer configured for receiving power from a power grid;
two three-level converters;
a rectifier coupling the input transformer to the converters;
a phase shifted output transformer coupled to the converters;
a motor coupled to the output transformer; and
a compressor coupled to the motor and configured for recovery of oil, gas, or combinations thereof.

17. The power conversion system of claim 16 wherein the power conversion system is operable in the frequency range extending up to at least 300 Hertz.

18. The power conversion system of claim 16 wherein the output transformer comprises a delta wound primary winding 56 and an open star wound secondary winding, and wherein one converter is coupled to the primary winding and another converter is coupled to the secondary winding.

19. The power conversion system of claim 18 wherein the converters each comprise a plurality of converter switches and further comprising a controller for selecting switching patterns of the converter switches to result in the one converter being thirty degrees out of phase with the other converter.

20. The power conversion system of claim 16 wherein the input transformer comprises two secondary windings with one secondary winding being star wound and another secondary winding being delta wound.

21. The power conversion system of claim 16 wherein each converter comprises a neutral point clamped converter.

22. A power conversion system for power generation, the power conversion system comprising:
a generator;
a phase shifted transformer configured for receiving power from the generator;
two three-level converters coupled to the input transformer, wherein the converters each comprise a plurality of converter switches and further comprising a controller for selecting switching patterns of the converter switches to result in one converter being out of phase with another converter.

23. The power conversion system of claim 22 wherein the converters comprise primary converters and further comprising an additional converter configured for coupling the primary converters to a power grid.
